(19) United States
(12) Patent Application Publication
(10) Pub. No.: US 2005/0177588 A1
(43) Pub. Date: Aug. 11, 2005

(54) Data communication bus

(75) Inventors: Danielle Rossi, Bologna (IT); Richard Petrus Kleihorst, Eindhoven (NL); Andre Krijn Nieuwland, Eindhoven (NL); Victor Emmanuel Stephanus Van Dijk, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/511,513

(22) PCT Filed: Apr. 1, 2003
(86) PCT No.: PCT/IB03/01311

(30) Foreign Application Priority Data
Apr. 17, 2002 (EP) 02076497.3

(51) Int. Cl. G06F 17/00

(52) U.S. Cl. 707/101

(57) ABSTRACT

An electronic device has a data communication bus (200) mounted on a semiconductor substrate (120). The data communication bus (200) has a first conductor (102), a second conductor (104), a third conductor (106) and a fourth conductor (108). The conductors have been reordered and the distances (I₁, I₂, I₃) between two neighboring conductors have been recalculated on the basis of the correlation between the data-bits conveyed by the conductors of the data communication bus (200), e.g. the number of times that the two transitions on two conductors have a predetermined value out of the total number of transitions on that conductor pair. Consequently, a data communication bus (200) is obtained in which the power consumption resulting from the charging of the cross-coupling capacitance between two neighboring conductors is reduced.

The invention relates to data communication means for communicating N-bit data, N being an integer with a value of at least three, the data communication means having a plurality of substantially parallel conductors comprising a first, a second and a third conductor for respectively communicating a first, a second and a third bit of the N-bit data, the first conductor having a first distance to the second conductor, and the second conductor having a second distance to the third conductor, the first distance being smaller than the second distance, said first distance being based on a first correlation between the first bit and the second bit and said second distance being based on a second correlation between the second bit and the third bit.

The ongoing downscaling of semiconductor technology dimensions has led to an increase in the component density per unit area on integrated circuits (ICs) and other electronic devices, thus enabling the integration of more components onto the IC, which has led to the development of more complex and more powerful devices.

However, this downscaling has also introduced unwanted side effects that are a possible threat to the correct functional behavior of the IC or the electronic device. For instance, the aforementioned increased component density has led to an increase in the interference between neighboring components. A well-known example of such interference is the increase in the mutual capacitance (Cₘ) between neighboring conductors of data communication devices, e.g. buses. This effect not only has a potentially detrimental effect on signal integrity, but also increases the overall power consumption of the data communication device. The latter is also an unwanted effect, because both the increase of the component density as well as the downscaling of the semiconductor technology dimensions add to the overall power consumption of an integrated circuit and associated electronic device. In fact, the IC power consumption is increasing to such an extent that meeting the power demands without jeopardizing the IC integrity is becoming a major issue. Therefore, measures to reduce the power consumption of the IC have become increasingly important.

In laid-open Japanese patent application 06-039886, a solution for reducing the power consumption of a data communication bus is disclosed. In this disclosure, it is recognized that conductors, e.g. wires, that show a high frequency of switching behavior are more subjected to increased power consumption due to the charging of Cₘ than conductors having a low switching frequency. In this disclosure, the conductors experiencing a large switching activity are the conductors responsible for the communication of the least-significant bits. Therefore, the distance between the conductors communicating the least-significant bits has been increased with respect to the distance between the conductors communicating the more significant bits in order to reduce the magnitude of Cₘ for wires having the largest switching activity.

It is a disadvantage that this solution increases the area covered by the data communication bus, e.g. its footprint. This has a negative effect on the integration level of the electronic device, e.g. the IC, in which the data communication bus is integrated, which results in an increase of the silicon real estate and associated cost of the device.

Inter alia, it is an object of the invention to provide data communication means of the kind described in the opening paragraph with power consumption reduction measures that do not necessarily increase the area covered by the data communication means.

The invention is defined by the independent claims. Advantageous embodiments are defined in the dependent claims.

The invention is based on the awareness that conditions exist where the switching behavior on neighboring conductors does not cause a charging of Cₘ for a large fraction of the transitions in the total N-bit data space. This ratio, e.g. the number of occurrences of N-bit data value transitions for which the bit value transitions on a neighboring conductor pair do not cause a (full) charging of Cₘ, divided by the complete set of N-bit data transitions occurring on the data communication means, is defined as the correlation between the two neighboring conductors. When this correlation is substantially higher than 50%, the cross-talk originating from the mutual, or cross-coupling, capacitance between these two conductors will be absent in a substantial number of all switching events on these neighboring conductors, because the respective values on the two neighboring conductors often change in the same direction, or Cₘ only has to be discharged, respectively. However, a pair of neighboring conductors having a correlation of substantially less than 50% will experience a frequent charging of Cₘ due to the fact that the conductors will often switch in opposite directions or one of the conductors will switch from a logic low to a logic high with the other conductor remaining a logic low, which also causes a charging of Cₘ. By having a relatively small distance between neighboring conductors with a high correlation and by having a larger distance between neighboring conductors with a low correlation, the overall power consumption of the data communication means is reduced without having to further increase the footprint of the data communication means. In other words, the present invention targets the increase of the effectiveness of the use of an available silicon real estate budget for reducing the detrimental effects of the mutual capacitances between the conductors rather than the increase of this budget to reduce these effects.

It is an advantage if the first bit is a bit of a data word and the second bit is an encoding bit of a fault-tolerant encoding method for the data word.

Unwanted effects that are introduced by the downscaling of semiconductor technology dimensions, like the increase in cross-talk between neighboring conductors, or the increased sensitivity to α-particles hitting the semiconductor substrate reducing the signal integrity of the conductors. This possibly leads to faulty interpretation of the data being communicated over the conductors, which can have catastrophic implications, for instance in situations where the electronic device experiencing faulty data transport is responsible for the control of traffic vehicles, e.g. high-speed trains, aircrafts, satellites and so on. Therefore, the application of fault-tolerant encoding methods, e.g. methods where a data word is combined with a number of encoding bits to form a codeword, is becoming increasingly useful in the semiconductor areas that are threatened to suffer from these detrimental effects. Now, the present invention is particularly suited for such applications, since the application of fault-tolerant techniques typically leads to a set of N-bit codewords of limited size, which makes the calculation of the correlation a feasible exercise. In addition, because of the relationship between the data bits and the encoding, e.g. parity, bits, usually a high correlation exists between these bits, which makes it particularly advantageous to communicate these bits over neighboring wires.

At this point, it is emphasized that, although optimal Hamming single error coding is a popular fault-tolerant coding method because the additional area overhead introduced by the introduction of parity bit conductors is limited due to the fact that a minimal amount of necessary encoding bits is used, it is unsuited to reduce the power consumption of data communication means by applying the teachings of the present invention. In Hamming coding, the codewords are formed in such a way that the bit pair correlation between all neighboring pairs of conductors is 50%. This excludes the possibility of reducing the power consumption because of the fact that for a bit pair correlation of 50% bits of equal value occur as often on two neighboring conductors as bits of opposite value, which implies that the transition correlation between these bits often will be 50% as well. Consequently, the only way of reducing crosstalk on Hamming encoded data communication means by means of interconductor distance variations is by increasing the distance between all neighboring conductors, which would lead to an unwanted increase in the footprint of the data communication means. Therefore, alternative encoding methods having a larger area overhead than Hamming encoding can be better suitable for application of the present invention, because of the potential higher correlation between neighboring conductors.

It is a particularly advantageous if the fault-tolerant encoding method is dual-rail encoding. In dual-rail encoding, a data bit is copied and the copy of the data bit is used as its parity. Now, by definition, the correlation between the data bit and the encoding bit is 100%, and the distances between the first and the second conductor can be kept as small as possible, since these wires will experience no crosstalk whatsoever. Consequently, the distance between the second and the third conductor, which will experience crosstalk, can be kept as large as possible, thus reducing the amount of crosstalk originating from the charging of the cross-coupling capacitance of neighboring wires to a largest possible extent.

It is a further advantage if the data communication means further comprise a fourth conductor for communicating a fourth bit of the N-bit data word, the fourth conductor having a third distance to the third conductor based on a third correlation between the third conductor and the fourth conductor. The formation of pairs of conductors having a high correlation leads to data communication means exhibiting reduced power consumption and having a layout in which the distance between two conductors in a pair is smaller than the distance between two pairs. This is particularly advantageous in the case of fault-tolerant data communication means employing dual-rail encoding, where all pairs of conductors have a correlation of 100%, which can lead to a very power efficient fault-tolerant arrangement.

According to a further aspect of the invention, an electronic device is provided as claimed in claim 4.

The inclusion of data communication means according to the present invention in an electronic device has advantages extending beyond the data communication means. The power consumption that is associated with data communication is reduced for such a device, which is particularly advantageous for battery-powered devices, because it has a direct positive impact on the contiguous operation time of the battery.

According to yet a further aspect of the invention, a method for designing data communication means is provided as claimed in claim 5.

By calculating the correlations between all pairs of wires, a footprint of the data communication means can be calculated based on the obtained correlations.

It is an advantage if the method further comprises the step of constructing a codebook of the N-bit data for calculating the first correlation and the second correlation. Such a codebook, e.g. a list of all possible words that can be communicated via the data communication means, provides a sound basis for the calculation of the correlations. Obviously, this is particularly useful in application domains where the set of all possible words that are expected to be communicated is significantly smaller than the set of all possible words, or where the set of all possible words itself is small enough to make such an exercise feasible.

It is a further advantage if the first bit is a bit of a data word and the second bit is an encoding bit of a fault-tolerant encoding method for the data word. Typically, the construction of a codebook is advantageous for fault-tolerant methods, since the number of codewords that can be communicated via the data communication means is limited to such an extent that it makes the construction of the codebook a feasible exercise. Furthermore, because of the intrinsic correlation between the data bit and the encoding bit, high correlations are expected to be found, which enhances the chances of success for the exercise.

It is another advantage if the method further comprises the step of changing an order of the first conductor, the second conductor and the third conductor to increase a sum of the first correlation and the second correlation.

The reordering of conductors within a data communication means is advantageous when non-neighboring conductors have a high correlation. The reordering increases the correlation between neighboring wires, which contributes to the reduction of the overall power consumption of the data communication means.

The invention is described in more detail and by way of non-limiting examples with reference to the accompanying drawings, wherein:

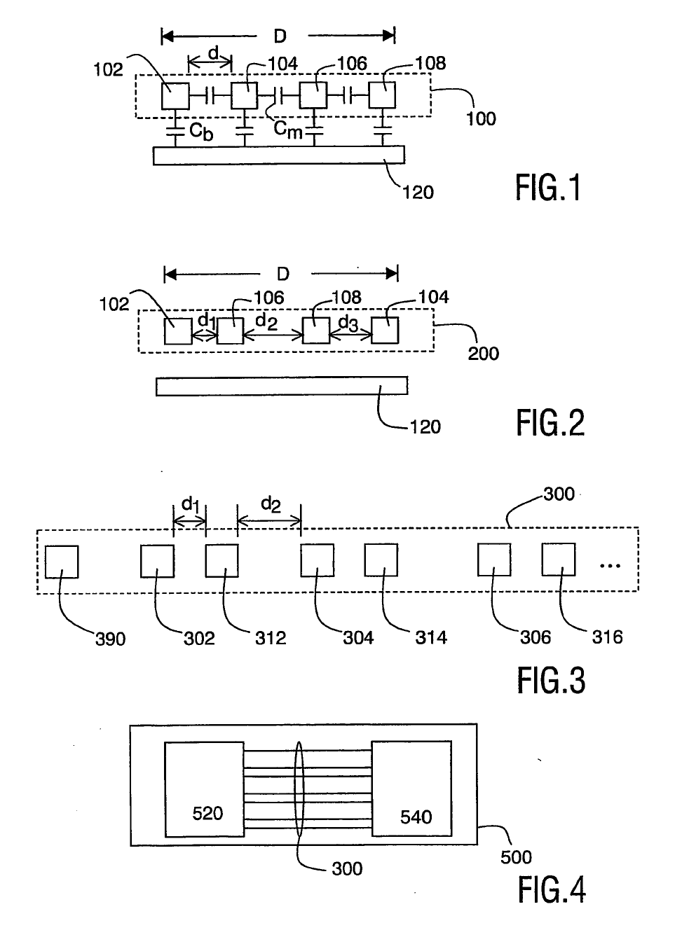

FIG. 1 depicts a schematic architecture of a data communication bus;

FIG. 2 depicts a schematic layout of a data communication bus according to the present invention;

FIG. 3 depicts a schematic layout of another data communication bus according to the present invention; and

FIG. 4 depicts an electronic device according to the present invention.

In FIG. 1, data communication means, e.g. a prior art data communication bus 100, are depicted. The data communication bus 100 is mounted on a semiconductor substrate 120 and has a first, second, third and fourth conductor, numbered 102, 104, 106, and 108 respectively. Conductor 102 is placed at a distance d with respect to neighboring conductor 104, which in its turn is placed at the same distance with respect to conductor 106 and so on; the neighboring conductors of the data communication bus 100 are equally spaced. The data communication bus has a total width, e.g. footprint, D, which is the width from the first conductor 102 to the last conductor of the data communication bus 100, which is conductor 108 in this example. Respective conductors 102, 104, 106, 108 all have a capacitance with the substrate 120, the so-called bottom-parallel plate capacitance, which has been schematically depicted in FIG. 1 and labeled C_{b}. In addition, the respective conductors 102, 104, 106, 108 also have a mutual, or cross-coupling, capacitance with their neighbors, which has also been schematically depicted in FIG. 1 and labeled Cₘ.

Typically, the cross-coupling capacitance is becoming a more and more dominant capacitance in future, high-density semiconductor devices, especially when the conductors of data communication bus 100 are arranged as closely next to each other as possible, which maximizes Cₘ and the associated power consumption. C_{b} is less dominant, because the distance between conductors 102, 104, 106 and 108 and substrate 120 does not necessarily decrease in future technologies, not in the least because more and more metal layers are being used, which in fact can lead to an increase in this distance and a decrease in C_{b} and the associated power consumption. Consequently, the most promising strategy to reduce the overall power consumption of data communication bus 100 is to reduce the contribution of Cₘ to this power consumption. A straightforward way is to simply increase the distance 1 between the conductors of data communication bus 100. Albeit effective, this has the disadvantage that footprint D becomes larger, which hampers the overall level of integration of the electronic device, e.g. integrated circuit.

However, a situation can exist where it is possible to predict which data words will be transmitted over data communication means like data communication bus 100 or other arrangements where a collection of conductors are arranged in close proximity of each other for data communication. This is for instance the case for the codewords of a fault-tolerant encoding method, because typically a relationship exists between the bits of the data part of the code word and the bits of the encoding part of the code word. The complete collection of words that are expected to be communicated via the data communication means is referred to as a codebook. In Table I, a codebook for data communication bus 100 is given.

TABLE I
Codebook for data communication bus 100.

| conductor | 102 | 104 | 106 | 108 |
|---|---|---|---|---|
| word 1 | 1 | 0 | 1 | 0 |
| word 2 | 1 | 1 | 1 | 1 |
| word 3 | 1 | 0 | 0 | 0 |
| word 4 | 0 | 0 | 0 | 1 |
| word 5 | 0 | 1 | 0 | 0 |
| word 6 | 1 | 0 | 1 | 1 |
| word 7 | 1 | 0 | 1 | 0 |
| word 8 | 0 | 1 | 0 | 1 |

The given values denote the bit values of the individual bits to be communicated via conductors 102, 104, 106 and 108 of data communication bus 100. As can be seen in Table I, the codebook consists of eight 4-bit words; these words represent all the words that are expected to be communicated via data communication bus 100.

Now, according to the method of the invention, a codebook containing K N-bit wide codewords Wₖ, e.g. Wₖ(0) . . . Wₖ(N−1), can be used to calculate the correlation C_{i,j} between bit positions i and j, e.g. between two conductors in a data communication device, using formula (1):

$${C}_{i , j} = {\sum }_{k = 0}^{k = K - 1} {\sum }_{l = 0}^{l = K - 1} \frac{{F ( {W}_{k} -> {W}_{l} )}_{i , j}}{{K}^{2}} \qquad ( 1 )$$

with (Wₖ→Wₗ)_{i,j} being the transition of bit i and j from word k to word 1, and F being a weight function to give a weight to each individual transition. For instance, a transition can be given a weight 1 when the transition does not alter the charge state of the mutual capacitance Cₘ between wires i and j. like for instance a 00→11 transition or a transition where the values of the bits remain the same, like a 01→01 transition. Other weight factors can be chosen without departing from the scope of the invention. In addition, it might be advantageous to use a more complex weight function; typically for a 01→10 transition the mutual capacitance between the wires has to be charged to an amount in the order of 2Cₘ because the polarity of the capacitor has to be reversed, whereas for a 00→01 transition the capacitor only has to be charged, which corresponds to an amount in the order of Cₘ. This difference in the amount of charge that has to be stored in the capacitor can also be taken into consideration when defining the weight function.

The outcome of formula (1) is a N×N matrix, with the autocorrelation of a bit line, e.g. a conductor, with itself on the diagonal of the matrix; the off-diagonal elements give the correlation between two conductors. This formula has been applied to the codebook of Table I using a simple weight function F wherein all transitions have weight 0, apart from the 00→11, 11→100 transitions and the transitions for which the data values on both conductors remain the same; these transitions have all been given a weight 1, since they do not require a (de)charging of the mutual capacitor of the conductor pair. The resulting 4×4 matrix is given in Table II.

TABLE II
Transition correlation matrix for the codebook of Table I.

| | 102 | 104 | 106 | 108 |
|---|---|---|---|---|
| 102 | 1 | 24/64 | 50/64 | 22/64 |
| 104 | 24/64 | 1 | 22/64 | 30/64 |
| 106 | 50/64 | 22/64 | 1 | 24/64 |
| 108 | 22/64 | 30/64 | 24/64 | 1 |

As can be seen from Table II, the correlations between the various conductors 102, 104, 106 and 108 of data communication bus 100 vary considerably. In the current layout of data communication bus 100, conductor 102 has a correlation of 24/64 with its neighboring conductor 104. Conductor 104 has a correlation of 22/64 with its other neighbor, conductor 106, which in its turn has a correlation of 24/64 with neighboring conductor 108. It is once again emphasized that the way the correlations in table II are constructed is chosen by way of example only; as previously mentioned, more elaborate functions F can be chosen, or other correlations can be constructed, without departing from the scope of the invention.

The data from Table II can be used to calculate the distances between the neighboring conductor by using the recurrence relation in formula (2):

$${d}_{s , s + 1 } = MAX [ \frac{1 - {C}_{s , s + 1 }}{{\sum }_{m = s}^{N - 2} ( 1 - {C}_{m , m + 1 } )} * ( {D}_{max} - {\sum }_{m = 0}^{s - 1} {d}_{m , m + 1} ) , {d}_{min} ] \qquad ( 2 )$$

wherein d_{s,s+1} is the distance going from conductor s to conductor s+1, dₘᵢₙ is the minimum distance, e.g. pitch, of the data communication bus and Dₘₐₓ is the maximum footprint. However, as can be seen in Table II, much higher correlations between two conductors are present in the correlation matrix than those of the neighboring conductor pairs 102, 104; 104, 106 and 106, 108. For instance, the correlation between conductor 102 and 106 is very high, 50/64, so it will be advantageous to reorder the conductor sequence of data communication bus 100 in order to maximize, or at least increase, the correlation between neighboring conductors, since this will have a positive effect of the reduction of the power consumption by data communication bus 100.

Therefore, before actually calculating the spacing d between the respective conductors with formula (2), it is advantageous to maximize, or at least increase, the sum of the correlation of the neighboring conductors of data communication bus 100, e.g. finding or approximating the expression depicted in formula (3), with C_{w} being the word correlation:

$${C}_{w} = MAX {\sum }_{s = 0}^{s = N - 1} {C}_{s , s + 1} \qquad ( 3 )$$

Application of formulas (3) and (2) on the correlation matrix of Table II will lead to a reordering of the conductors 102, 104, 106, and 108 as shown in FIG. 2, thus yielding a data communication bus 200 according to the present invention. From Table II, it is obvious that the largest correlations found between the conductors 102, 104, 106 and 108 are a correlation of 50/64 between conductors 102 and 106 and a correlation of 30/64 between conductors 108 and 104. The application of formula (3) has yielded a layout in which the order of first, second, third and fourth conductor has become 102, 106, 108 and 104 respectively, with respective correlations of 50/64, 24/64 and 30/64. This is also reflected in the respective distances d1, d2 and d3, as obtained with formula 2; d1<(d2, d3) and d3<d2, which reflects the scaling of the distance between two neighboring conductors with their correlation.

As previously explained, the present invention is particularly suitable for application to fault-tolerant data communication architectures, e.g. fault-tolerant data communication buses, due to the fact that there can be a high correlation between data bit and the encoding, e.g. parity, bit, depending on the applied fault-tolerant method. For instance, in dual-rail encoding, every data bit is copied and the copy is applied as a parity bit for the data bit. An additional check bit is included to determine whether the a bit of the data word or the parity word has become faulty; if the data word is faulty the parity word will be used and vice versa.

According to an advantageous aspect of the invention, the fault-tolerant method of dual rail encoding is particularly suitable for application in architectures according to the present invention, because the correlation between data bit and accompanying parity is 100% by definition, which means that when these bits are being communicated over neighboring conductors, these conductors will never experience cross-talk resulting from their joint switching behavior, unless an error occurs on one of the two conductors. Consequently, pairs of conductors, each pair containing a conductor for communicating a data word bit and one conductor for communicating an encoding bit can be formed with a minimum pitch distance between the two conductors of the pair. On the other hand, the distance between two pairs of conductors will be larger, because the correlation between two neighboring conductors from two pairs will be much lower; typically this correlation will have a value indicating a near-random switching behavior between these conductors.

It is emphasized that the present invention is not limited to dual-rail encoding; other fault tolerant techniques can be used having their own respective distances between the conductors based on the correlations present in the associated codebooks.

FIG. 3 shows a schematic layout of a data communication bus 300 including dual-rail encoding according to the present invention. Data communication bus 300 has a first conductor 302 forming a pair with second conductor 312 for communicating a first data bit and a first encoding bit of an N-bit wide codeword; a third conductor 304 forming a pair with fourth conductor 314 for communicating a second data bit and a second encoding bit of an N-bit wide codeword, and a fifth conductor 306 forming a pair with second conductor 316 for communicating a third data bit and a third encoding bit of an N-bit wide codeword. Obviously, this arrangement has to be extended to N pairs of conductors for an N-bit wide codeword, as indicated by the dots in the right hand side of FIG. 3. In addition, data communication bus 300 has an additional conductor 390 for communicating the dual-rail encoding check bit of the dual-rail encoding. The distance d₂ between two neighboring conductors belonging to two different pairs is larger than the distance d1 between two conductors belonging to a single pair, thus reflecting the larger correlation between the latter two conductors. Typically, d₂ is approximately 1.5-2.5 times as large as d₁. The optimal ratio between d₁ and d₂ depends on Dₘₐₓ and dₘᵢₙ and can be calculated with formula (2). The ratios in the aforementioned range give significant power reductions, even over fault-tolerant data communication buses having a minimum amount of resources, e.g. data communication buses employing optimal Hamming fault-tolerant encoding, which requires only [log₂ k]+1 parity bits for k data bits rather than the k+1 bits required by dual rail encoding. In addition, the power-delay product and associated power efficiency of the N-bit data communication bus 300 of the present invention is also better than that of a similar Hamming code N-bit data communication bus, as has been demonstrated using SPICE simulations on both layouts.

In FIG. 4, an electronic device 500 according to the present invention is shown. Electronic device 500 has a first module 520 and a second module 540, which are arranged to communicate with each other via a data communication bus according to the present invention, e.g. dual-rail encoding data communication bus 300. It is emphasized that dual-rail encoding data communication bus 300 has been included in FIG. 4 by way of non-limiting example only; other data communication means according to the present invention can be used as well. The use of such data communication buses in an electronic device 500 is particularly advantageous for battery-powered devices, e.g. laptop computers, mobile phones, handheld personal assistants and so on, because it prolongs the contiguous operational times of the batteries of such devices, which is an important marketing quality. Consequently, implementation of a data communication bus according to the invention in an electronic device 500 improves the quality of electronic device as a whole.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be

1. Data communication means for communicating N-bit data, N being an integer with a value of at least three, the data communication means having a plurality of substantially parallel conductors comprising a first, a second and a third conductor for respectively communicating a first, a second and a third bit of the n-bit data, the first conductor having a first distance to the second conductor, and the second conductor having a second distance to the third conductor, the first distance being smaller than the second distance;
characterized in that the first distance is based on a first correlation between the first bit and the second bit, and the second distance is based on a second correlation between the second bit and the third bit.

2. Data communication means as claimed in claim 1, characterized in that the first bit is a bit of a data word and the second bit is an encoding bit of a fault-tolerant encoding method for the data word.

3. Data communication means as claimed in claim 2, characterized in that the fault-tolerant encoding method is dual-rail encoding.

4. Data communication means as claimed in claim 1, characterized in that the data communication means further comprise a fourth conductor for communicating a fourth bit of the N-bit data word, the fourth conductor having a third distance to the third conductor based on a third correlation between the third bit and the fourth bit.

5. Electronic device comprising a first module and a second module, characterized in that the first module is coupled to the second module via data communication means according to any of the preceding claims.

6. Method for designing data communication means for communicating N-bit data, N being an integer with a value of at least three, the data communication means having a plurality of substantially parallel conductors comprising a first, a second and a third conductor for respectively communicating a first, a second and a third bit of the N-bit data, the first conductor having a first distance to the second conductor, and the second conductor having a second distance to the third conductor, the first distance being smaller than the second distance;
characterized in that the method comprising the steps of:
calculating a first correlation between the first bit and the second bit;
calculating a second correlation between the second bit and the third bit;
determining the first distance based on the first correlation; and
determining the second distance based on the second correlation.

7. A method as claimed in claim 6, characterized by further comprising the step of constructing a codebook of the N-bit data for calculating the first correlation and the second correlation.

8. A method as claimed in claim 7, characterized in that the first bit is a bit of a data word and the second bit is an encoding bit of a fault-tolerant encoding method for the data word.

9. A method as claimed in claim 7, characterized by further comprising the step of changing an order of the first conductor, the second conductor and the third conductor to increase a sum of the first correlation and the second correlation.
